(19) United States
(12) Patent Application Publication
(10) Pub. No.: US 2007/0063492 A1
(43) Pub. Date: Mar. 22, 2007

(54) Airbag for inflating outside a vehicle

(75) Inventor: Tadahiro Igawa, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/516,741

(22) Filed: Sep. 7, 2006

Related U.S. Application Data
(60) Provisional application No. 60/714,413, filed on Sep. 7, 2005.

(51) Int. Cl. B60R 21/16; B60R 21/235

(52) U.S. Cl. 280/730.1; 280/743.1

(57) ABSTRACT

An airbag for deployment outside of a vehicle is made from a fabric that is coated on at least one of the surfaces of the fabric. The airbag fabric may be coated to increase the strength of the fabric so that the fabric is reinforced. By increasing the strength of the fabric, breakage of the airbag can be minimized. By employing an airbag that is made from a fabric that is coated on at least one of the surfaces of the fabric, the airbag is less likely to decrease in strength when the airbag comes into contact with a foreign object that presses or scratches against the airbag. The vehicle may be a motorcycle, automobile, train or other vehicle.

### CROSS-REFERENCE TO RELATED PATENT APPLICATIONS

This application claims the benefit under 35 U.S.C. § 119 (e) of U.S. patent application Ser. No. 60/714,413, filed Sep. 7, 2005, which is incorporated herein by reference in its entirety.

### BACKGROUND

The present invention relates to an airbag and an airbag module for deploying outside of a vehicle, in which the airbag includes a coated fabric.

Conventional airbags may be deployed outside of vehicles to aid in the protection of vehicle occupants or people outside of the vehicle. For example, conventional airbags may be deployed outside of motorcycles to aid in the protection of the driver of the motorcycle. In another example, conventional airbags may also be deployed outside of automobiles to aid in the protection of pedestrians that may be struck by the automobiles. However, conventional airbags that are deployed outside of vehicles do not use coated fabrics.

### SUMMARY

According to an embodiment of the invention, an airbag module is provided. The airbag module comprises an airbag with a fabric panel; and an inflator to inflate the airbag outside of a vehicle. The at least one fabric panel includes a coating on at least one surface of the fabric panel. The coating, when applied to the fabric panel, is configured to increase the strength of the fabric panel.

It is to be understood that both the foregoing general description and the following detailed description are exemplary and explanatory only, and are not restrictive of the invention.

### BRIEF DESCRIPTION OF THE DRAWINGS

These and other features, aspects, and advantages of the present invention will become apparent from the following description and the accompanying exemplary embodiments shown in the drawings, which are briefly described below.

FIG. 1 shows a side view of a motorcycle with an airbag, according to an embodiment of the present invention.

FIG. 2 shows a side view of an automobile with airbags deployed outside of the automobile, according to an embodiment of the present invention.

FIG. 3 shows a perspective view of an airbag according to an embodiment of the present invention.

FIG. 4 shows a sectional view of an airbag according to an embodiment of the present invention.

### DETAILED DESCRIPTION

It is an object of the present invention to provide an airbag for deployment outside of a vehicle, where the airbag is made from a coated fabric. It is an object of the present invention to provide an airbag module for deploying an airbag outside of a vehicle, where the airbag is made from a coated fabric.

According to an embodiment of the present invention, an airbag for deployment outside of a vehicle includes an airbag, wherein the airbag is made from a fabric that has a coating on at least one surface of the fabric.

According to an embodiment of the present invention, an airbag module for deploying an airbag outside of a vehicle includes an inflator and an airbag, wherein the airbag is made from a fabric that has a coating on at least one surface of the fabric.

According to an embodiment of the present invention, an airbag for deployment outside of a vehicle is provided, in which the airbag is made from a fabric that is coated on at least one of the surfaces of the fabric. The airbag fabric may be coated to increase the strength of the fabric so that the fabric is reinforced. By increasing the strength of the fabric, breakage of the airbag can be minimized. For example, airbag breakage due to contact with foreign objects may be minimized by coating the fabric, thereby increasing the strength of the fabric. By employing an airbag that is made from a fabric that is coated on at least one of the surfaces of the fabric the decrease in the strength of the airbag can be alleviated when the airbag comes into contact with a foreign object that presses or scratches against the airbag.

According to an embodiment of the present invention, an airbag module is provided for deploying an airbag outside of the vehicle. The airbag module includes an inflator and an airbag, where the airbag is made from a fabric that is coated on at least one of the surfaces of the fabric.

According to an embodiment of the present invention, the airbag may be made from a fabric that is coated on at least one of the surfaces of the fabric. For example, the fabric may be coated so that the inner surface of the airbag is coated, the fabric may be coated so that the outer surface of the airbag is coated, the fabric may be coated so that a partial coating is applied to the inner surface and/or outer surface of the airbag, or the fabric may be coated so that both the inside and outside surfaces of the airbag are coated.

Embodiments of the present invention will be described below with reference to the drawings.

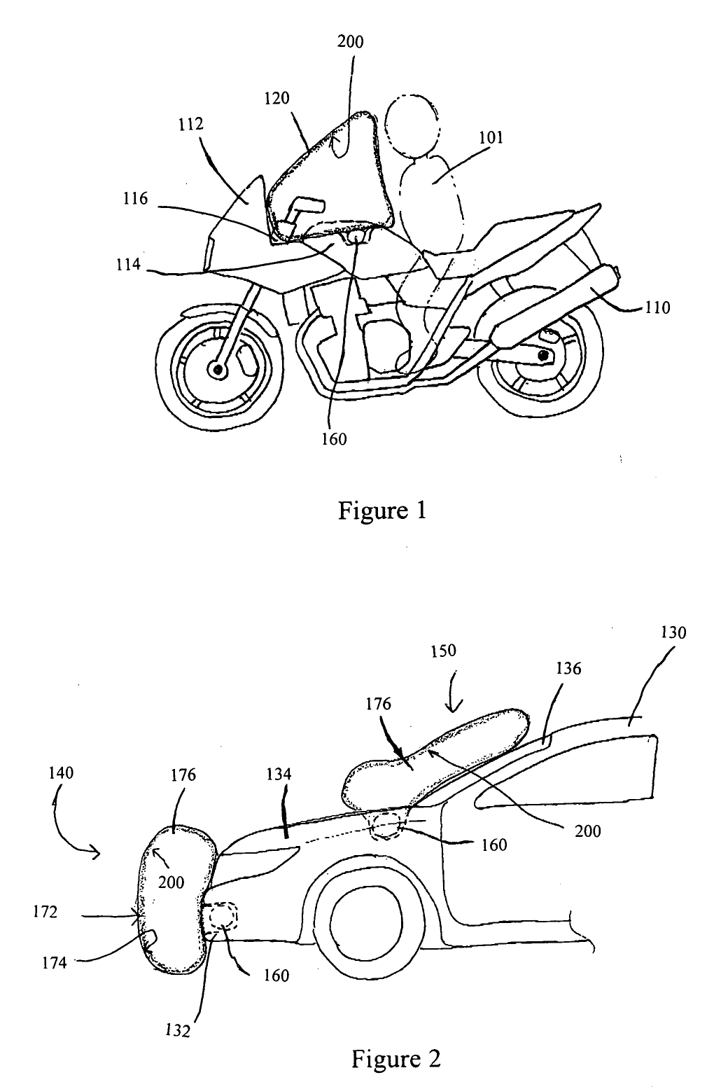

FIG. 1 illustrates a side view of an embodiment of the present invention in which a coated airbag 120 is employed with a motorcycle 110 so that the airbag 120 deploys outside the body of the motorcycle 110. In the example of FIG. 1, the airbag 120 is configured to deploy in front of the motorcycle driver 101 so that the airbag 120 may aid in the protection of the motorcycle driver 101 during an emergency, such as a collision. The airbag module, comprising the airbag 120 and inflator 160, is arranged on a motorcycle body part 114 so that the airbag 120 deploys between a steering column 116 and the driver 101.

In another embodiment, the airbag 120 may be positioned on the opposite side of the windshield 112 (in a front portion of the motorcycle 110) in order protect a pedestrian during a collision. Alternatively, the motorcycle 110 may include a plurality of airbags 120 in appropriate locations.

FIG. 2 shows a side view of an embodiment of the present invention in which coated airbags 140, 150 are employed with an automobile 130 so that the airbags 140, 150 deploy outside of the automobile 130. In the example of FIG. 2, a first airbag 140 is adapted to deploy so that the airbag 140 covers a front portion of the automobile 130. For instance, the airbag 140 may be arranged to surround the bumper 132 of the vehicle 130 to aid in the protection of pedestrians that may come into contact with the automobile 130, and to aid in the prevention of damage to the automobile 130.

FIG. 2 also shows a second exemplary airbag 150 that is arranged to cover the windshield 136 of the automobile 130 and a portion of the hood 134. This second airbag 150 may be employed to aid in the protection of a pedestrian that comes into contact with the automobile 130, to aid in the protection of the automobile occupants who might be harmed by objects that come into contact with the automobile 130, and to aid in the prevention of damage to the automobile 130. FIG. 2 shows examples of airbag module configurations that include an airbag 140, 150 with a fabric panel 176 which includes an outer surface 172 and an inner surface 174, and an inflator 160. One or both of the outer and inner surfaces 172, 174 may include a coating 200.

It will be recognized that one or more airbags 140, 150 may be utilized on the outside of the vehicle 130. Further, one or more airbags 140, 150 may be positioned in other suitable locations, such as along the side of the vehicle 130, on the roof, the door, adjacent a wheel, or in any other suitable location.

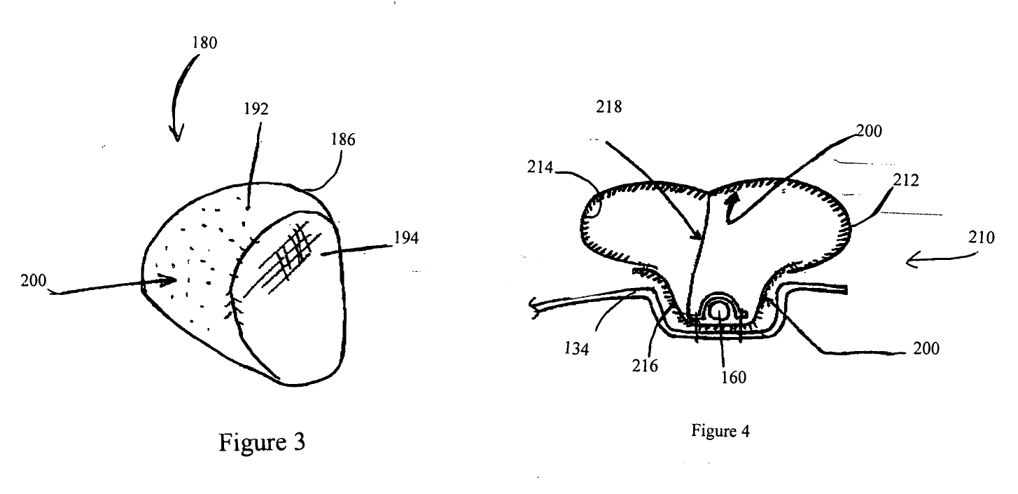

FIGS. 3 and 4 illustrate a perspective view and a sectional view of airbags, according to embodiments of the present invention. The perspective view in FIG. 3 shows an airbag 180 made from a fabric 186 that is coated so that a first portion 192 of the airbag 180 has a coating 200 and a second portion 194 of the airbag 180 is not coated. According to this embodiment, the airbag 180 may be arranged so that the coated surface is the surface 192 of the airbag 180 that comes into contact with foreign objects. This configuration may be employed when the surface 192 of the airbag 180 that comes into contact with foreign objects may be specified. The non-coated surface 194 of the airbag 180 may be used as a non-contacting surface of the airbag 180. In this embodiment, the coating 200 is on the outer surface of the contacting portion 192 of the airbag. Alternatively, the coating 200 may be applied to the inner surface or both the inner and outer surfaces of the contacting portion 192 of the airbag 180.

The sectional view of the airbag 210 in FIG. 4 illustrates an example of an airbag 210 that is deployed from the hood 134 of a vehicle, such as an automobile. This airbag design may be used to protect a pedestrian that comes into contact with the vehicle. The airbag 210 may include one or more tethers 218 to control the deployed shape of the airbag 210. In this exemplary embodiment, one tether 218 is shown. Furthermore, the fabric 212 of the airbag 210 may be coated with a coating 200 so that the inner surface 214 of the airbag 210 is coated, providing protection to the airbag fabric 212 from heated gases that are produced by the airbag inflator 160 during deployment of the airbag 210. In the example of FIG. 4, the fabric 212 of the airbag 210 is coated so that the outside surface 216 of the airbag 210 is coated. By coating the outside surface 216 of the airbag 210, the airbag 210 may be reinforced to aid in the prevention of the decrease in the strength by damaging the airbag due to the airbag 210 coming into contact with foreign objects or into contact with surfaces of the vehicle, such as the hood 134.

The present invention may be used in various vehicles. For example, the airbag and airbag module of the present invention may be used in motorcycles, automobiles, and trains. In the example of automobiles, the present invention may be used to cover a part or whole of the windshield, to cover a front portion of the vehicle surrounding the bumper, to cover a part or whole hood or fender of the vehicle, or combinations of these examples. In the example of a trains, the present invention may be used to cover a front portion of the train to protect pedestrians.

According to an embodiment of the present invention, the coating material for the airbag fabric is a resin or a rubber. For example, the coating material may be silicone rubber, polyurethane, chloroprene rubber, or other fabric coating material known in the art.

According to an embodiment of the invention, an airbag, such as a pedestrian protecting airbag that inflates outside of a vehicle, coating of the airbag may be advantageous to maintain the inflated state of the airbag. An airbag that inflates outside of a vehicle may be required to remain inflated for longer periods of time compared to an airbag that inflates inside a vehicle. Thus, the coating of a fabric panel on the airbag may help maintain the inflated state of the airbag by alleviating a gas leakage from a weaving line of the fabric panel and caused by damaging the fabric panel due to surrounding foreign objects in inflating the airbag.

In an embodiment of the invention, prior to coating the airbag fabric may have a tear strength from 150N to 200N and, after coating, may have an increased tear strength of ten percent or more. In another embodiment of the invention, the airbag fabric, after coating, may have an increased tear strength in the range of ten to thirty percent. In yet another embodiment, the airbag fabric, after coating, may have an increased tear strength in the range of fifteen to twenty five percent.

In an embodiment of the invention, an airbag fabric may have a tear strength of 190N prior to coating and, after coating, may have an increased tear strength to 230N. In this case, the tear strength may be increased to approximately twenty percent.

According to an embodiment, an exemplary tear strength in the warp and weft direction may be determined by the following exemplary method. It will be recognized that other tear strength methods may be used. To determine tear strength, five test pieces of airbag fabric with a size of 50×100 mm in warp and weft direction are tested in a tensile tester. Each test piece is cut to form a slit at a right angle from an edge of the test piece. The slit is cut in the shorter edge and extends toward the center of the test piece. The slit test piece is arranged between a 50 mm clamp and fixed in a direction for tearing. The load at the time of tearing of the test piece is recorded; with the tensile velocity of the tensile tester approximately 200 (100)±10 mm/min using an automatic feeder chart. The test results may be an average value from data of multiple maximum values for each warp and weft value. Abnormal values may be included separately.

According to an embodiment of the present invention, the airbag may be a polymer, such as polyamide, polyester, or other fabric material known in the art. The filament constituting the fabric panel may be in a range of 200 to 700 dtex.

An airbag or airbag module of the present invention may employ any combination of fabric material, filament constituting the fabric panel, coating material, and coating surface configuration described above.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is :

1. An airbag module, comprising:
an airbag with a fabric panel; and
an inflator to inflate the airbag outside of a vehicle,
wherein the at least one fabric panel includes a coating on at least one surface of the fabric panel, the coating, when applied to the fabric panel, being configured to increase the strength of the fabric panel.

2. The airbag module of claim 1, wherein the coating is applied to an inside surface of the fabric panel.

3. The airbag module of claim 1, wherein the coating is applied to an outside surface of the fabric panel.

4. The airbag module of claim 1, wherein the coating is applied to an inside surface and outside surface of the fabric panel.

5. The airbag module of claim 1, wherein the fabric panel has a filament in a range of 200 to 700 dtex.

6. The airbag module of claim 1, wherein the fabric panel has a filament in a range of 200 to 500 dtex.

7. The airbag module of claim 1, wherein the fabric panel has a filament in a range of 500 to 700 dtex.

8. The airbag module of claim 1, wherein the coating comprises silicone rubber.

9. The airbag module of claim 1, wherein the coating comprises polyurethane.

10. The airbag module of claim 1, wherein the coating comprises chloroprene rubber.

11. The airbag module of claim 1, wherein the fabric panel comprises a polyamide material.

12. The airbag module of claim 1, wherein the fabric panel comprises a polyester material.

13. The airbag module of claim 1, wherein before the coating, the fabric panel comprises a tear strength from 150N to 200N and, after the coating, the fabric panel comprises an increased tear strength of ten percent or more.

14. The airbag module of claim 13, wherein the fabric panel with coating comprises a tear strength from 200N to 300N.
